(19) United States
(12) Patent Application Publication
(10) Pub. No.: US 2025/0190169 A1
(43) Pub. Date: Jun. 12, 2025

(54) COHORT ASSIGNMENT AND CHURN OUT PREDICTION FOR ASSISTANT INTERACTIONS

(71) Applicant: GOOGLE LLC, Mountain View, CA (US)

(72) Inventors: Ankur Aggarwal, San Jose, CA (US); Meng Xu, Mountain View, CA (US); Nisha Tiwari, San Jose, CA (US); Amir Raminfar, Pleasanton, CA (US)

(21) Appl. No.: 18/396,189

(22) Filed: Dec. 26, 2023

Related U.S. Application Data
(60) Provisional application No. 63/609,255, filed on Dec. 12, 2023.

(51) Int. Cl. G06F 3/16

(52) U.S. Cl. CPC G06F 3/167

(57) ABSTRACT

Implementations set forth herein relate to assigning users to cohorts and generating assistant content for presenting to the user based on their respectively assigned cohort and to reduce user churn out. Each cohort can belong to a plurality of cohorts that vary according to the level of experience, proficiency, and/or engagement that a user has historically exhibited with respect to a particular application and/or feature. A user can be assigned to multiple cohorts in circumstances in which a user may be proficient with respect to certain features of an application but not other features. When a user is estimated to be churning out or otherwise disengaging with respect to a particular feature, assistant content associated with that particular feature can be generated and rendered at a particular time that may not distract the user and may result in further engagement with the particular feature.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

In some instances, computing devices can rely on cloud processing to realize client assistant functionality, as well as on-device processing. For encouraging usage of some assistant functionality, current systems may provide user suggestions in form of text, sounds, and/or graphics at an interface of a client device that provides access to the automated assistant. However, some systems may indiscriminately render suggestions thereby wasting network bandwidth to send assistant content to users that may already be expert users. When this practice of indiscriminately rendering content is performed over an entire user population, the amount of resources that are wasted can be significant, especially relative to an alternative practice of simply not providing such content, and the suggestions may not be tailored to the user's understanding and/or engagement with the assistant. However, considering certain suggested features can prove beneficial to non-expert users, omitting such suggestions altogether may not be the most efficient use of resources. For example, suggesting assistant features that can make a user safer while driving can prove beneficial to the health and well-being of the user-but constantly suggesting such features can waste resources when suggested to a different user who is already regularly employing those features.

### SUMMARY

Implementations set forth herein relate to classifying a user interaction into a particular cohort for suggesting content that can encourage usage of an application feature associated with the user interaction. Additionally, or alternatively, classifying the user interaction into a particular cohort can be performed to limit suggestions for a user that may exhibit an estimated level of experience or proficiency with the application feature. In some implementations, a particular cohort can be selected for a user based on how available interaction data characterizes the interaction between the user and the automated assistant. For example, the particular cohort that a user is assigned can indicate a level proficiency the user has exhibited with respect to frequency of usage of one or more features of the automated assistant (e.g., how often the user utilizes one or more of the features of the automated assistant) and/or with respect to duration of usage of one or more features of the automated assistant (e.g., how long ago the user initially utilized one or more of the features of the automated assistant). In some implementations, a user can be assigned to two or more cohorts, such that each assigned cohort can indicate a level of experience, and/or complexity of prior interactions, the user has had with a respective feature of the automated assistant. In this way, suggestions and/or explanations of different assistant features can be rendered for a user according to the cohort or cohorts that are assigned to that user.

As an example, consider a user who is experienced with using their automated assistant at home via their many assistant-enabled home devices, such as a standalone display interface, their cellular phone, and/or other assistant-enabled home devices. The user can be proficient with respect to invoking and controlling their automated assistant via voice commands to their assistant-enabled home devices, and via touch commands to their cellular phone. Interaction data characterizing interactions between this user and the automated assistant can be utilized to assign the user and/or these interactions to a particular cohort and/or multiple cohorts. For example, a first cohort can be assigned to indicate that the user regularly uses (e.g., at least X times every Y period, where X is a positive integer and Y quantifies a length of time) a first feature of the automated assistant, such as a voice command feature of an assistant-enabled home device. As a result, assistant content can be generated proactively for providing suggestions regarding other features the user may be interested in, beyond the feature they are already proficient with, and in lieu of providing content that the user is already familiar with.

In some implementations, the automated assistant can be accessible via a vehicle computing device for controlling various applications while the user is in their vehicle, and/or for controlling the vehicle (or various components of the vehicle, such as an air conditioning system, an entertainment system, etc.). Continuing with the above example, assume the user who is experienced with using their automated assistant at home is has just purchased a new vehicle and has therefore never utilized the automated assistant via the vehicle computing device, the user can be assigned to a second cohort (e.g., that differs from the first cohort associated with using their automated assistant at home), at least with respect to features associated with the vehicle computing device. Therefore, and in some implementations, the user can be assigned to multiple different cohorts simultaneously, and these cohort assignments can change as the user's level of proficiency and/or experience with certain automated assistant features changes. The second cohort can be assigned to the user in furtherance of providing the user with assistant content that can familiarize the user with certain assistant features the user may not otherwise be familiar with. For example, when the user enters their vehicle and activates a display interface in the vehicle, the automated assistant can cause assistant content to be rendered based on the user's assignment to the second cohort. The assistant content can be rendered simultaneously with other application content and can provide a basic suggestion for a feature that may assist the user during driving (e.g., “You can place a phone call while driving by simply tapping the assistant button on your steering wheel and saying “Call [Name].”).

As interactions between the user and the automated assistant change over time, the user can be re-assigned to different cohorts for different automated assistant functionalities. Such re-assignments can occur when the user is becoming more or less proficient with a feature or their automated assistant, when the user seems to be more or less interested in engaging with their automated assistant, and/or at any other time during the lifetime of usage of the automated assistant by the user. For example, a user that was otherwise proficient with using their automated assistant for searching the internet may abruptly stop using this automated assistant feature for a threshold duration of time (e.g., N-number of days, weeks months, etc., where Nis a positive integer). Based on this stoppage occurring for the threshold duration of time, the automated assistant can estimate that the proficiency of the user for this assistant feature has declined and, as a result, cause the user to be assigned to a second cohort that is different from their previously-assigned first cohort. The second cohort can be reserved for users who exhibit a lower degree of proficiency or experience with an assistant feature relative to other users, such as those assigned to the first cohort. Based on this updated assignment to the second cohort, the automated assistant can proactively generate assistant content to be rendered for the user to encourage the user to return to their prior level of proficiency with an assistant feature.

Depending on how a user responds to content that is generated based on the user's assigned cohort, one or more trained machine learning models can be further trained according to the content and/or the user's response. In this way, the one or more trained machine learning models can be further enhanced for assisting with generating content that can encourage proficiency of certain assistant features and/or user adoption of certain features (i.e., avoiding user churn out). In some implementations, the one or more trained machine learning models, or other models or heuristic method(s) can be utilized to determine when a user may be churning out with respect to a particular feature of their automated assistant and/or another application. Alternatively, or additionally, trained models and/or heuristic methods can be utilized to determine a suitable opportunity to suggest assistant content to a user. In this way, a user who is focused on driving and/or performing another task will not be distracted by assistant content intended to boost their engagement and/or familiarity with a particular feature. Rather, the assistant content can be rendered at a particular time, or within a threshold duration of time, that the user is estimated to be able to engage with the assistant content.

For example, the automated assistant can determine that a user assigned to a first cohort (e.g., a cohort for relatively proficient users) is churning out with respect to a feature for assisting the user with finding nearby parking. Based on this determination, and instead of rendering related assistant content while the user is driving, the assistant content can be rendered at a display interface of a vehicle computing device the next time the user enters their vehicle. This decision to render the assistant content at this particular time can be based on training data that indicates other users assigned to the first cohort and who are estimated to be churning out with respect to this particular feature were less likely to churn out of the first cohort if they received this first assistant content before the beginning of a drive, rather than during or at the end of the drive. Alternatively, the automated assistant can determine that a user assigned to a second cohort is not often utilizing the feature very often and, based on this determination, can proactively generate second assistant content for presenting to this other user. Training data can indicate that the other users assigned to the second cohort and who are not often utilizing this feature are less likely to chum out if they receive this other assistant content while stopped in their vehicle before they reach a destination. Therefore, based on this training data and the other users being assigned to the second cohort, the automated assistant can cause this other assistant content to be rendered at the display interface of vehicle computing the next time the user is stopped in their vehicle.

Although the above examples are described with respect to only a first cohort and a second cohort, it should be understood that is for the sake of example and is not meant to be limiting. Rather, it should be understood that the various cohorts described herein can be defined in various manners and modified over time. For instance, although the first cohort is defined in an example above as including users that utilize an assistant feature at least X times every Y period (where X is a positive integer and Y quantifies a length of time), it should be understood that is not meant to be limiting. Further, it should be understood that different cohorts can be defined for different features and/or applications with varying degrees of interaction and/or durations of time.

By reserving certain assistant content to certain users according to their cohort, significant resources can be preserved, in terms of processing bandwidth, power, and network resources, and suggestions that are provided can be tailored to the user's understanding and/or engagement with the assistant. When the aforementioned implementations are deployed on a mass scale (e.g., across a pool of millions of users), the savings on power, network bandwidth, and storage can be immensely beneficial. For example, by assigning users to separate cohorts rather than to a single cohort, a number of suggestions and/or educational content delivered to users of certain cohorts can be reliably decreased without affecting user retention and/or user proficiency, and while also taking into account different levels of understanding an engagement with an automated assistant. Furthermore, even when proficient users no longer engage with a feature of their automated assistant and are thus estimated to be churning out, the fact that those users were not previously bombarded with suggestions and content during their time as a proficient user would have preserved significant resources. Moreover, by dynamically assigning users and/or interactions to cohorts and estimating user engagement and/or user chum out, application programming interfaces (APIs) can become more advanced and specialized with respect to their abilities to uniquely serve users. This can prove particularly useful as when certain types of models (e.g., large language models) are deployed by automated assistants to serve users but inherently require detailed context to do so effectively.

The above description is provided as an overview of some implementations of the present disclosure. Further description of those implementations, and other implementations, are described in more detail below.

### BRIEF DESCRIPTION OF THE DRAWINGS

FIG. 1A, FIG. 1B, and FIG. 1C illustrate views of a user interacting with an automated assistant that relies on assigned user cohorts to make cohort-specific suggestions to users that may or may not be disengaging with their respective assistant.

FIG. 2 illustrates a system for classifying a user and/or user interaction into a particular cohort for suggesting content that can encourage usage of an application feature associated with the user and/or user interaction, in accordance with various implementations.

FIG. 3 illustrates a method for implementing a system for assigning users and/or user interactions to one or more particular cohorts for tailoring assistant content for certain users and/or omitting rendering certain content for other users, in accordance with various implementations.

FIG. 4 is a block diagram of an example computer system, in accordance with various implementations.

### DETAILED DESCRIPTION

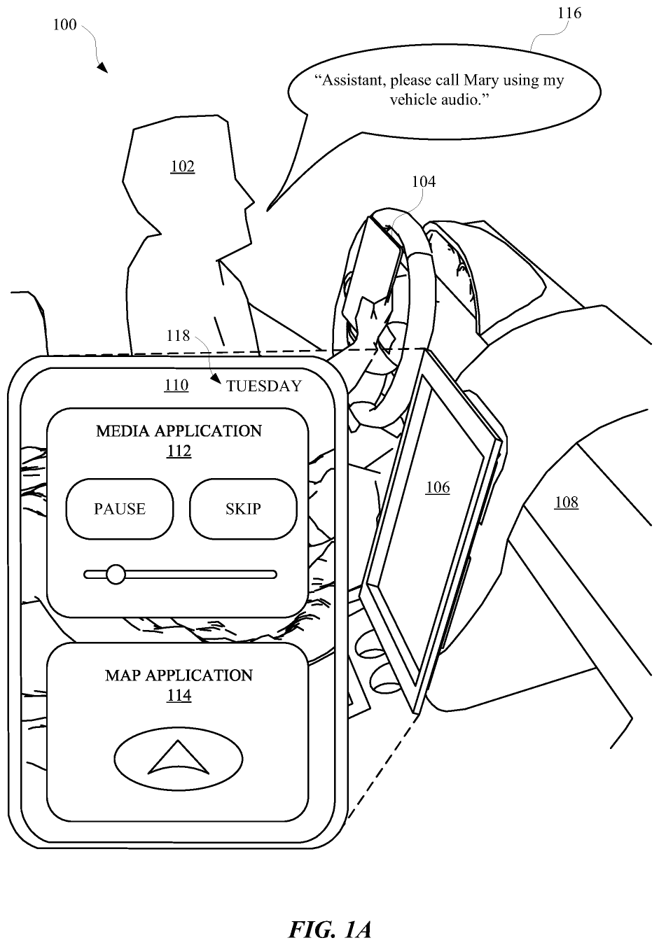

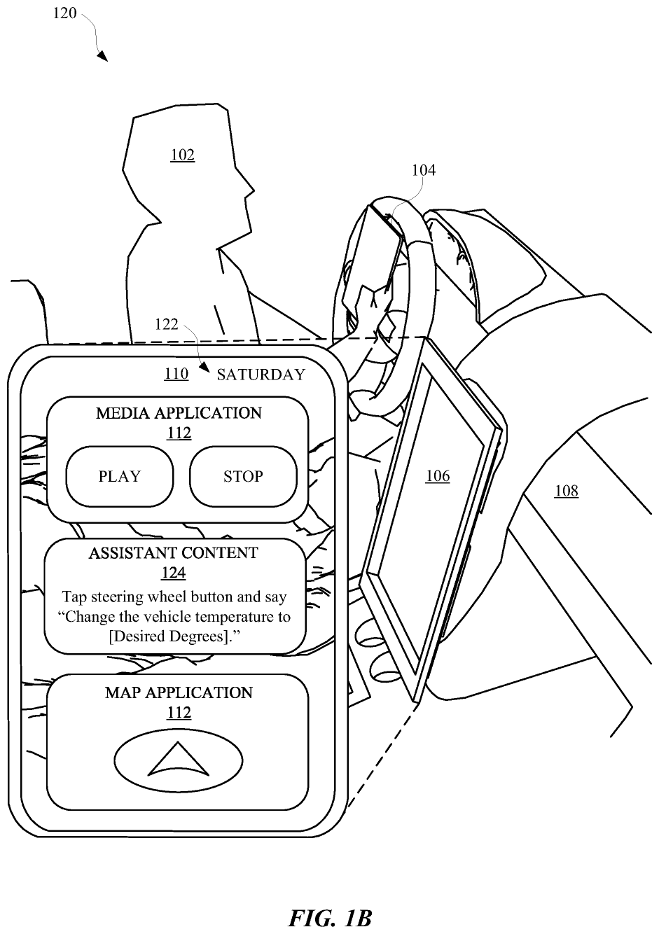

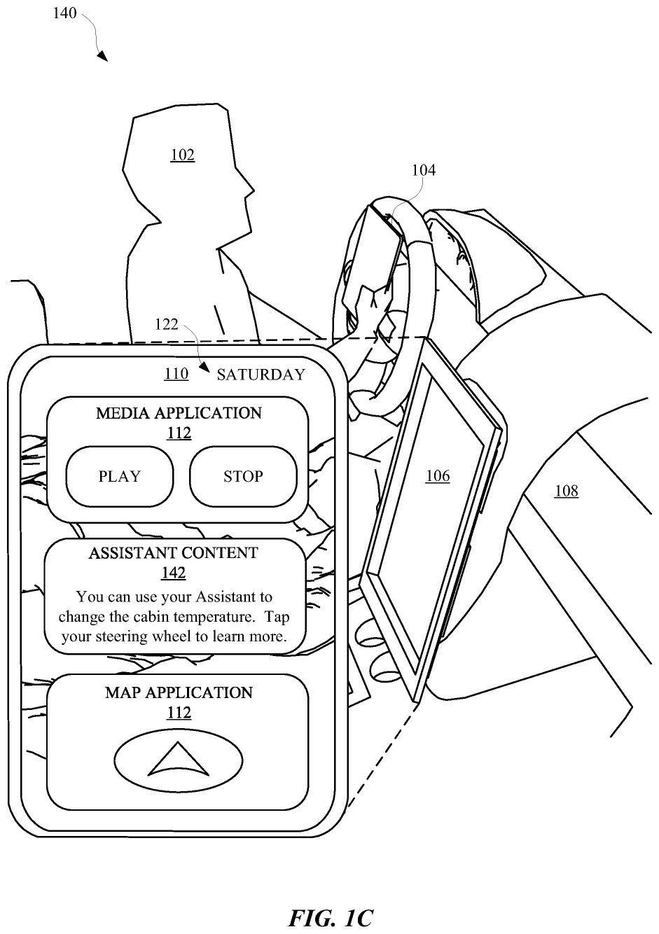

FIG. 1A, FIG. 1B, and FIG. 1C illustrate a view 100, a view 120, and a view 140 of a user 102 interacting with an automated assistant that relies on assigned user cohorts to make cohort-specific suggestions to users that may or may not be disengaging (i.e., “churning out”) with respect to their automated assistant, features of their automated assistant, and/or other applications or features of those other applications. For example, the user 102 can be in their vehicle 108 when engaging with their automated assistant by providing a spoken utterance 116 such as “Assistant, please call Mary using my vehicle audio.” The spoken utterance 116 can be received at an audio interface of a computing device 106 that can be integral to the vehicle 108. In response to receiving the spoken utterance 116, the automated assistant can determine a particular cohort for the user 102 and/or for the interaction, at least when the user 102 and/or the interaction have yet to be assigned to a cohort. For example, a cohort can be selected from a plurality of cohorts, and each cohort of the plurality of cohorts can vary according to an estimated level of expertise of the user 102, an estimated degree of experience to interact with the automated assistant in the way that the user 102 interacted with the automated assistant, an estimated degree of skill to employ a feature that the user 102 employed during the interaction, and/or any other combination of indicators association with a user and/or an interaction.

When the user 102 has been assigned to a cohort, the automated assistant can also determine whether the user 102 is subsequently predicted to churn out with respect to engaging with their automated assistant, features of their automated assistant, and/or other applications or features of those other applications. In other words, the automated assistant can estimate, and optionally with prior permission from the user 102, whether the user 102 is estimated to engage with their automated assistant, features of their automated assistant, and/or other applications or features of those other applications, either less frequently and/or not at all. In some implementations, this estimation can be based on data generated by the vehicle computing device 106, another client computing device 104 of the user, and/or any other client or server device associated with the user 102.

For example, when the user 102 is estimated to not churn out with respect to the voice calling feature specified in their spoken utterance 116, the automated assistant can bypass rendering any assistant content at a display interface 110 of the vehicle computing device 106. As illustrated in FIG. 1A, the display interface 110 can be rendering other applications (e.g., a media application 112 and a map application 114) when determining that the user 102 is not estimated to churn out and, thus, not render the assistant content in response. Alternatively, or additionally, during the instance of time 118 (e.g., “TUESDAY” depicted in FIG. 1A), the user 102 can be estimated to be churning out with respect to another feature of the automated assistant (e.g., an assistant feature for hands-free control of vehicle temperature). Nonetheless, the automated assistant can determine a more desirable time to render the assistant content related to this other feature. For example, the more desirable time can be based on data accessible via one or more applications, devices, and/or other apparatuses or modules associated with the user 102. A selection of the more desirable time can be based on an estimated amount of engagement and/or attention a user may be willing to give to certain assistant content at a particular time. In some implementations, the determination of the next desirable time for rendering the assistant content can be based on one or more heuristic processes and/or one or more trained machine learning models. For example, the one or more trained machine learning models can be trained using labeled data that identifies content and a time that a user was presented with the content, and labels indicating whether the user engaged with the content and/or associated application at or near the time of presentation.

For example, and as illustrated in FIG. 1B, assistant content 124 can be generated and rendered for the user 102 according to their assigned cohort, and at a different time 122 (e.g., “SATURDAY” as depicted in FIG. 1B) than when the user 102 was estimated to churn out with respect to their automated assistant, features of their automated assistant, and/or other applications or features of those other applications. Regarding FIG. 1B, the user 102 may have been estimated to be churning out or otherwise disengaging with the assistant feature for hands-free control of vehicle temperature initially at the time 118 corresponding to FIG. 1A. However, and based on processing data using one or more heuristic processes and/or one or more trained machine learning models, the automated assistant can determine that a more effective time for presenting assistant content is a different time 122, corresponding to FIG. 1B. Based on this determination, assistant content 124 can be rendered at the display interface 110 of the vehicle computing device 106.

In some implementations, the assistant content 124 that is generated and rendered can vary according to the cohort that the user 102 is assigned to. For example, assistant content 124 that is generated can be based on the user 102 being assigned to a relatively more experienced assistant user cohort, such as a cohort that has employed certain features of the automated assistant and/or a threshold number of features of the automated assistant. Alternatively, or additionally, the relatively more experienced cohort can be assigned to those users who have utilized the hands-free control of vehicle temperature feature of the automated assistant within the last X months, but not within the last Y weeks (where X and Y represent positive integers). As a different example, the assistant content that is rendered can be different when the user 102 has been assigned to a cohort of relatively less advanced assistant users.

For example, and as illustrated in FIG. 1C, assistant content 142 generated for users assigned to a relatively less experienced cohort (e.g., relative to users assigned to other cohorts (e.g., the cohort described above with respect to FIG. 1B)) can be presented with less complex assistant content (e.g., content that describes fewer steps towards receiving information about an assistant feature). As illustrated in view 140 of FIG. 1C, the assistant content 142 can advise the user 102 to merely tap a steering wheel button to learn more about the hands-free control of vehicle temperature feature of their automated assistant. In response to selecting the steering wheel button, the automated assistant can render an audio, textual, and/or graphical output via the vehicle computing device 106 or other computing device 104 describing how to further utilize the hands-free temperature control feature. By rendering certain assistant content according to the assigned user cohort, the assistant can encourage user retention and utilization of certain features (with prior express permission from the user) without indiscriminately rendering content for other users that may be familiar with the specified feature.

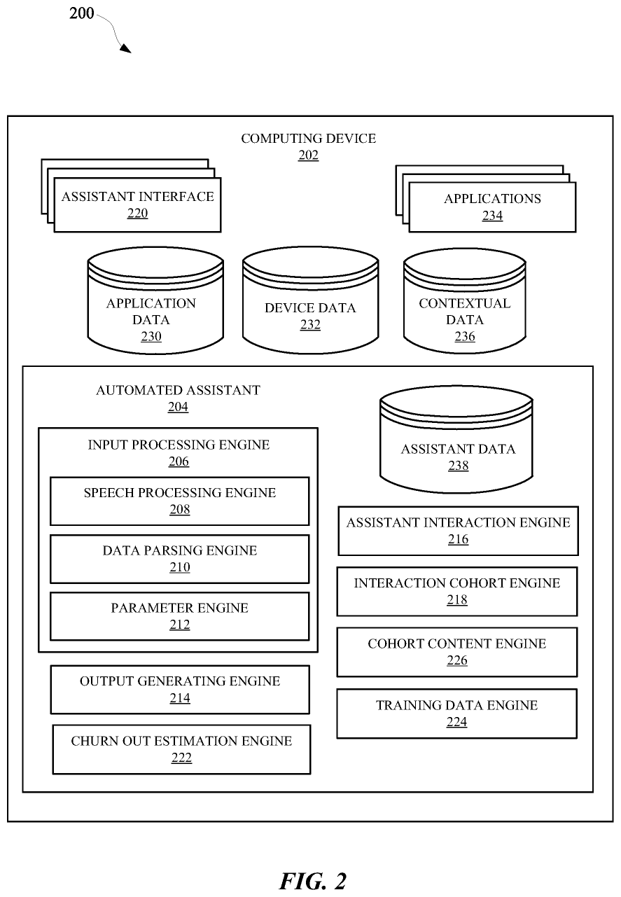

FIG. 2 illustrates a system 200 for classifying a user and/or user interaction into a particular cohort for suggesting content that can encourage usage of an application associated with the user, an application feature associated with the user and/or user interaction. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera but can optionally include one or more other sensors.

The computing device 202 and/or other third-party client devices can be in communication with a server device over a network, such as the Internet. Additionally, the computing device 202 and any other computing devices can be in communication with each other over a local area network (LAN), such as a Wi-Fi® network or Bluetooth Network®. The computing device 202 can offload computational tasks to the server device in order to conserve computational resources at the computing device 202. For instance, the server device can host the automated assistant 204, and/or the computing device 202 can transmit inputs received at one or more assistant interfaces 220 to the server device. However, in some implementations, the automated assistant 204 can be hosted at least in part at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202 and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and/or on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

However, in various implementations, the on-device NLU module and/or the on-device fulfillment module can be replaced and/or supplemented with a large language model (LLM) module that utilizes LLM(s) to generate content that is responsive to any spoken utterances or other user inputs. The on-device LLM module can utilize any LLM, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory. Notably, the LLM that is utilized can include billions of weights and/or parameters that are learned through training the LLM on enormous amounts of diverse data. This enables the LLM to generate LLM output as a probability distribution over a sequence of tokens (e.g., words, word units, or other representations of words) and based on processing user inputs, contextual data, and/or other data. Further, output from the LLM can be determined based on the probability distribution for the sequence of tokens.

In various implementations, remote speech processing module(s), remote NLU module(s), remote fulfillment module(s), and/or remote LLM module(s) can at least selectively be utilized. For example, recognized text can at least selectively be transmitted to remote automated assistant component(s) for remote NLU, remote fulfillment, and/or remote LLM processing. For instance, the recognized text can optionally be transmitted for remote performance in parallel with on-device performance, or responsive to failure of the on-device NLU module, the on-device fulfillment module, and/or the on-device LLM module. However, on-device processing and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine (not depicted) of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine (not depicted) of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., the device data 232) can be accessed by the automated assistant 204 to generate contextual data 236, which can characterize a context in which a particular application 234 and/or device is executing, and/or a context in which a particular user is accessing the computing device 202, accessing one or more applications 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static but can be accessed by the application state engine in order to determine a suitable action to initialize via the automated assistant 204.

In some implementations, the system 200 can include an assistant interaction engine 216 for determining whether one or more users are interacting with their automated assistant 204, and/or other application 234. Alternatively, or additionally, the assistant interaction engine 216 can determine one or more features that a user is interacting with. For example, when a user is interacting with a standalone display device in their home, the assistant interaction engine 216 can determine a feature that the user is engaging with via their standalone display device. In some implementations, the assistant interaction engine 216 can process data, with prior express permission from the user, for determining an estimation of proficiency, skill, and/or experience that the user has with the particular feature based on this and/or other interactions. This estimation of proficiency and/or other experience metric can be shared with an interaction cohort engine 218 of the system 200 for assigning an interaction cohort to the user and/or the interaction.

In some implementations, the interaction cohort engine 218 can process data generated by the assistant interaction engine 216 for selecting and/or creating an interaction cohort to assign to the user and/or the interaction. The data can be processed using one or more heuristic processes and/or one or more trained machine learning models (e.g., using a logistic regression model or other modeling technique) to select a particular interaction cohort from a plurality of interaction cohorts, or generate an additional interaction cohort (e.g., when data instances indicate a separate group if apparent using logistic regression). In some implementations, a user and/or interaction exhibiting a relatively low level of experience can be assigned to a first interaction cohort, can be assigned to a second interaction cohort when the user and/or the interaction exhibits a relatively higher level of experience, and/or other cohorts based varying levels of experience. When an interaction cohort has been assigned to a user and/or an interaction, a cohort content engine 226 can be utilized to generate assistant content for the user, according to their assigned interaction cohort.

In some implementations, the assistant content generated by the cohort content engine 226 can be created based on one or more heuristic processes and/or one or more trained machine learning models that have been refined based on feedback from one or more users (and the feedback optionally being received with prior express permission from the user). For example, assistant content can be generated for a first user cohort to suggest that the user perform an operation that may require less steps to accomplish relative to other assistant content that is generated for a second user cohort. Alternatively, or additionally, the cohort content engine 226 can generate assistant content that is proven to encourage accomplish user retention and/or minimize user churn out for each respective interaction cohort. In other words, assistant content can be generated based on whether the content would minimize user churn out for a particular interaction cohort, rather than minimizing user churn out for all interaction cohorts. Furthermore, the assistant content can be rendered at a particular time, place, device, and/or application interface according to an optional determination by a churn out estimation engine 222. Although the one or more heuristic processes and/or one or more trained machine learning models are described as being refined based on feedback from one or more users, it should be understood that can be performed in a decentralized manner, and that utilization of one or more heuristic processes and/or one or more trained machine learning models can be performed locally at the computing device 202, where updates to one or more heuristic processes and/or one or more trained machine learning models can be received from a server.

The churn out estimation engine 222 can process other data utilized by the system 200 to determine a time to render assistant content at a time that would encourage a user to not churn out, while also not distracting a user at a time when they may be engaged in another activity. In some implementations, this other data can include application data 230, device data 232, and/or contextual data 236 from one or more applications, devices, and/or other apparatuses or modules. In some implementations, determining an optimal time to present the assistant content can be performed using one or more heuristic processes and/or trained machine learning models (e.g., using a logistic regression model or other modeling technique), which can be trained using training data generated using a training data engine 224. For example, a time can be selected based on training data that indicates content presented at certain times resulted in less user churn out with respect to a particular feature. In some implementations, the training data can be locally generated (e.g., at a client device) for providing optimized suggestions for the user without invoking a cloud service, and/or can be generated at a remote computing device (e.g., a server) for providing suggestions that are optimized for a plurality of users. Furthermore, the training data engine 224 can generate training data for optimizing models that can be utilized for generating the assistant content, selecting interaction cohorts, creating interaction cohorts, and/or otherwise discouraging user churn out.

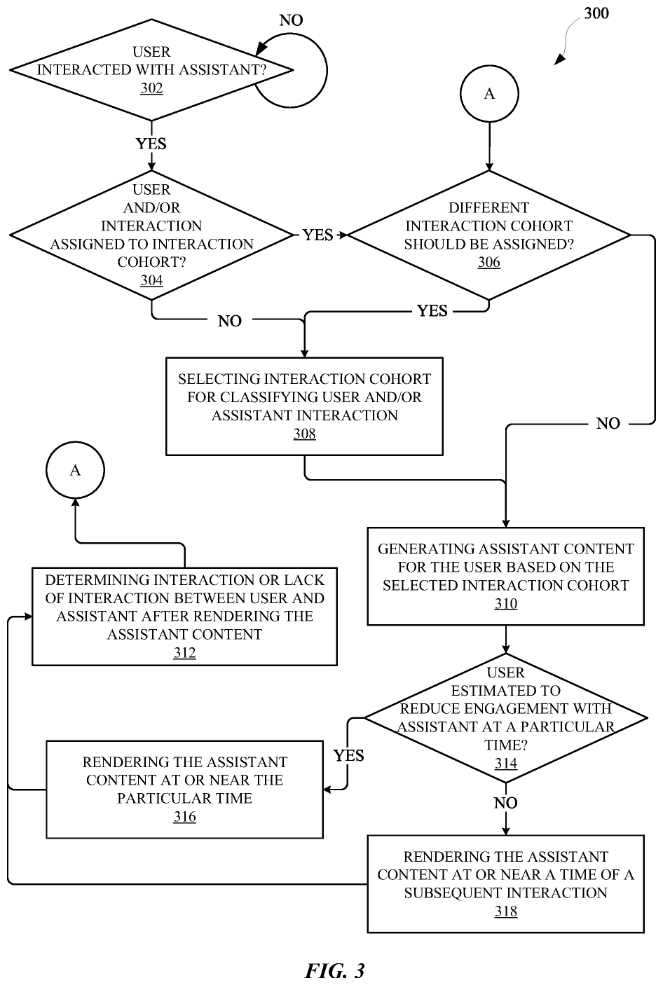

FIG. 3 illustrates a method 300 for implementing a system for assigning users and/or user interactions to one or more particular cohorts for tailoring assistant content for certain users and/or omitting rendering certain content for other users. The method 300 can be performed by one or more applications, devices, and/or any other apparatus or module capable of facilitating interactions with and/or of an automated assistant. The method 300 can include an operation 302 of determining whether a user has interacted with an automated assistant via one or more client devices and/or any other apparatus or module. The interaction can be, for example, between the user and a vehicle computing device that is integral to a vehicle (e.g., an SUV or other car), and the interaction can involve invoking the automated assistant to initiate a voice call to another person. Although the above example is described with respect to a vehicle computing device, it should be understood that is for the sake of example and is not meant to be limiting, and that interactions with other computing devices are contemplated herein. The computing device can be one or more of: a desktop computer, a laptop computer, a tablet, a mobile phone, a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided. The method 300 can proceed from the operation 302 to an operation 304 when the user is determined to have interacted with the automated assistant.

The operation 304 can include determining whether the user and/or the interaction has been assigned to an interaction cohort that is selected from a plurality of interaction cohorts. The interaction cohort can be characterized by a stored table, schema, and/or other collection of data stored at a client computing device, server computing device, and/or combination thereof. For example, each particular cohort can be associated with a level of experience a user has with a particular application, such as an automated assistant, and/or one or more features of the application. Alternatively, or additionally, each particular cohort can be associated with an amount of time, or number of separate instances, that the user has interacted with a particular application and/or feature, and/or an amount of time since the user has last interacted with the particular application and/or feature. In some implementations, each particular cohort can be associated with a type of prediction regarding whether the user will churn out and/or stop using a particular application and/or application feature. In some implementations, each cohort can be created, modified, and/or removed from a plurality of cohorts over time as a user and/or collection of users interact with one or more applications and/or one or more application features. For example, N number of cohorts (where N is a positive integer) can be initially available for assigning to a particular user and/or interaction, and after a duration of time has transpired and/or one or more interactions have been initiated by one or more users, M number of cohorts (where M is also a positive integer) can be available, where M is a number that is the same or different from the number N. Although the above example is described with respect to the user being assigned to a cohort based on interacting with the automated assistant, it should be understood that a user can also be assigned a cohort based on lack of any interactions with the automated assistant. When a user and/or interaction has been assigned to an interaction cohort, the method 300 can proceed from the operation 304 to an operation 306. Otherwise, the method 300 can proceed from the operation 304 to an operation 308.

The operation 306 can include determining whether the user and/or the interaction should be assigned to a different cohort. In some implementations, when certain criteria are no longer satisfied for assigning the user and/or interaction to a first interaction cohort (e.g., a less experienced user cohort), a different interaction cohort for that user and/or interaction can be selected from a plurality of interaction cohorts and assigned. For example, when the user is assigned to a cohort (e.g., a first cohort) that has never utilized an assistant voice calling feature, and, thereafter, utilizes the assistant voice calling feature, the user can be assigned to a different interaction cohort (e.g., a more experienced user cohort, such as a second cohort). This different cohort can be associated with criteria that is satisfied when, for example, the user has utilized any voice control feature of their automated assistant, in the past X weeks (or days, hours, etc.) (where X is a positive integer), and while driving or otherwise performing another activity.

The operation 308 can be performed when the user and/or interaction has not yet been assigned to an interaction cohort and/or when a different interaction cohort is to be assigned to the user and/or the interaction. For example, when the user has utilized the assistant voice calling feature after having never used the feature before, the user can be assigned to an interaction cohort corresponding to users who have used the voice calling feature within the last 10 days. Thereafter, the interactions the user has with the automated assistant can cause the user to be assigned to different cohorts such as, for example, cohorts associated with more advanced users and/or less advanced users. The method 300 can proceed from the operation 308 and/or the operation 306 to an operation 310 thereafter.

The operation 310 can include generating assistant content for the user based on the selected interaction cohort. The assistant content can be, for example, any application content that can be associated with a feature of one or more applications, and optionally specific to the cohort to which the user is assigned for the feature of one or more of the applications. In some implementations, the assistant content can include text, audio, and/or graphics that can be rendered for suggesting and/or facilitating usage of one or more application features. In some instances, assistant content generated for a first cohort assigned to users of relatively high experience can include descriptions and/or suggestions for advanced features of an automated assistant, device, and/or any other application. Furthermore, assistant content generated for a second cohort, assigned to other users of relatively less experience, can include other descriptions and/or other suggestions for less advanced features of the automated assistant, the device, and/or any of the other applications. For example, users can be assigned to the first cohort because they are considered advanced users with respect to assistant voice calling, and therefore may be shown suggestions that omit descriptions of the voice calling features the users are determined to be familiar with. However, other users can be assigned to the second cohort because they are not considered advanced voice calling users, and therefore can be shown the descriptions of voice calling features that those other users may not be familiar with. In some implementations, the users assigned to the first cohort may be shown suggestions less frequently than the other users assigned to the second cohort, thereby preserving resources for an entire population of client devices, at least relative to a scenario in which all users receive assistant suggestions at the same frequency.

The method 300 can proceed from the operation 310 to an operation 314 of determining whether the user is estimated to reduce their engagement with the automated assistant, application, and/or any other feature of a device, at or near a particular time or duration of time. For example, one or more trained machine learning models and/or heuristic methods can be utilized to process data from one or more sources, such as applications and/or devices associated with a user. A result of such processing can be an estimate that a user may “churn out” or otherwise reduce their engagement with a particular application and/or application feature. Alternatively, or additionally, the result of such processing can be an estimate of a particular time and/or a duration of time that the user may “churn out” or otherwise reduce their engagement with the particular application(s) and/or application feature(s). For example, a user who has not engaged with any assistant voice calling feature for a week may be estimated to no longer engage with the assistant voice calling feature. In particular, the user may be considered to “churn out” as of the next time they enter their vehicle, at least as a result of the user entering the vehicle and not engaging with their automated assistant. In response, and according to the method 300, the user can be presented with assistant content according to their assigned cohort. This content can be rendered in furtherance of encouraging the user to employ assistant features that can make them safer and can reduce wasting of resources across populations of user devices. When the user is estimated to reduce their engagement with a particular application and/or application feature at a particular time and/or a duration of time at the operation 314, the method 300 can proceed from the operation 314 to an operation 316. Otherwise, the method 300 can proceed from the operation 314 to an operation 318.

The operation 316 can include rendering the assistant content at or near the particular time and/or duration of time. For example, when a user who is assigned to an inexperienced user (or less-experienced user) cohort enters their vehicle at a time when they are estimated to be “churning out” with respect to their assistant calling feature, a display interface in their vehicle can render the assistant content. The assistant content can include natural language content, text, and/or graphics, and/or be rendered with corresponding audio to convey a message such as “Tap your steering wheel button to invoke the assistant for placing phone calls.” Alternatively, when a user assigned to an experienced user (a more experienced user) cohort enters their vehicle at a time when they are estimated to be “churning out” with respect to their assistant calling feature, a display interface integral to their vehicle can be rendered with different assistant content. This different assistant content can be, for example, an assistant message conveying information (e.g., natural language content, other graphics, etc.) about an advanced assistant calling feature that the user may or may not have utilized before, and that may involve more steps or operations than the assistant content shown to less experienced users. For example, the assistant message conveyed to the user can include “Hold your steering wheel button and say, ‘Call Tracy’ to initiate a call.”

The operation 318 can involve rendering the assistant content at or near a time of a subsequent interaction and/or anticipated interaction. For example, any assistant content can be rendered at or near the time of a subsequent interaction, such as when the user is interacting with the automated assistant, and/or a different application and/or computing device. For example, although the assistant content to be rendered can be associated with a voice calling feature, the subsequent interaction can involve a different feature, such as controlling an IoT device (e.g., invoking the automated assistant to control a smart thermostat). The assistant content can be rendered at a display interface associated with utilizing the video calling feature (e.g., a vehicle display interface) and/or another device interface (e.g., a cellular phone). Therefore, when the user is interacting with the automated assistant to control the IoT device during an interaction (e.g., a voice interaction), the automated assistant can render the assistant content (e.g., “I've adjusted your home thermostat setting. Please see your phone for helpful recommendations regarding other assistant features, such as assistant voice calling and task reminders . . . . [Assistant content is then rendered at the phone]”).

Subsequent to, and/or during, the operation 316 and/or the operation 318, the operation 312 can be performed for determining an interaction or lack of interaction between the user and the assistant (or other application or application feature) after rendering the assistant content. Depending on the determined interaction or lack of interaction with the assistant, application, and/or assistant content, the method 300 can proceed from the operation 312, via continuation element “A”, to the operation 306. In this way, the one or more trained machine learning models and/or heuristic methods for determining a particular cohort for a user can be updated according to feedback from the user in response to the assistant content. Alternatively, or additionally, this can allow the user to be assigned to a different cohort based on the interaction and/or lack of interaction between the user and the assistant, application, feature, and/or assistant content.

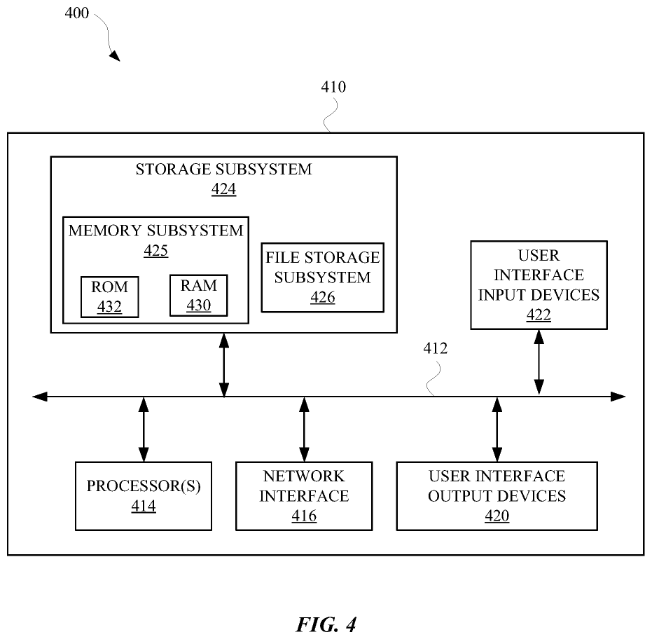

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, vehicle 108, automated assistant, and/or any other application, device, apparatus, and/or module discussed herein.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided, the method includes determining, based on client interaction data, a prior interaction a user has had with an automated assistant that is accessible via a computing device. The client interaction data is generated based on the prior interaction between the user and the automated assistant. The method further includes selecting, based on the prior interaction the user had with the automated assistant, a particular interaction cohort for classifying the user and/or the prior interaction. The particular interaction cohort is selected from a plurality of interaction cohorts that vary according to an estimated level of experience a particular user has had with the automated assistant and/or a feature of the automated assistant. The method further includes, subsequent to selecting the particular interaction cohort for classifying the user and/or the prior interaction, generating, based on the particular interaction cohort selected for the user and/or the prior interaction, assistant content for rendering at an interface of the computing device or a separate computing device. Different assistant content is generated for other users associated with other interaction cohorts of the plurality of interaction cohorts. The method further includes causing the computing device or the separate computing device to render the assistant content at the interface, in furtherance of informing the user about one or more features employed by, or not employed by, the user during the prior interaction.

These and other implementations of technology disclosed herein can optionally include one or more of the following features.

In some implementations, the method may further include, subsequent to causing the computing device or the separate computing device to render the assistant content at the interface, determining, based on subsequent client interaction data, a subsequent interaction, or lack of interaction, between the user with the automated assistant. The subsequent client interaction data may be generated based on the subsequent interaction, or lack of interaction, between the user and the automated assistant. The method may further include causing one or more trained machine learning models to be further trained based on the subsequent interaction, or lack of interaction, between the user and the assistant content. Generating the assistant content for rendering at the interface may involve utilizing the one or more trained machine learning models.

In some versions of those implementations, the method may further include, subsequent to causing the computing device or the separate computing device to render the assistant content at the interface, selecting, based on the subsequent interaction of the user, a separate interaction cohort from the plurality of interaction cohorts. The separate interaction cohort may correspond to a more experienced user cohort relative to the particular interaction cohort.

In additional or alternative versions of those implementations, the method may further include, subsequent to causing the computing device or the separate computing device to render the assistant content at the interface, selecting, based on the subsequent interaction of the user, a separate interaction cohort from the plurality of interaction cohorts. The separate interaction cohort may correspond to a less experienced user cohort relative to the particular interaction cohort.

In some implementations, the client interaction data may indicate multiple different features of the automated assistant that the user has utilized via the computing device or the separate computing device.

In some implementations, the method may further include, subsequent to selecting the particular interaction cohort for classifying the user and/or the prior interaction. determining that the user is estimated to reduce engagement with the automated assistant at a particular time, or within a threshold duration of the particular time. Causing the computing device or the separate computing device to render the assistant content at the interface may be performed at the particular time.

In some versions of those implementations, the computing device may be a vehicle computing device that is directly attached to, and controls, a vehicle. Further, determining that the user is estimated to reduce engagement with the automated assistant may be based on available interaction data indicating current or past engagement of the user with the vehicle computing device and/or the automated assistant.

In some further versions of those implementations, the available interaction data may indicate that, at the particular time, the user has ceased controlling the vehicle within a threshold duration of time, and/or the vehicle is parked or stopped.

In additional or alternative versions of those implementations, the automated assistant may be an application that facilitates internet searching. Further, determining that the user is estimated to reduce engagement with the automated assistant may be based on available interaction data indicating current or past engagement of the user with the application.

In some further versions of those implementations, the available interaction data may indicate that, at the particular time, the application has, or has not, received an input from the user within a threshold duration of time.

In some implementations, a method implemented by one or more processors is provided, the method includes determining, based on client interaction data, one or more prior interactions a user has had with an automated assistant that is accessible via a computing device. The client interaction data is generated based on the one or more prior interactions between the user and features of the automated assistant. The method further includes selecting, based on the one or more prior interactions between the user and the features of the automated assistant, interaction cohorts for classifying the user and/or the one or more prior interactions. Each interaction cohort of the interaction cohorts is selected from a plurality of interaction cohorts that vary according to a respective estimated level of experience a particular user has had with the automated assistant and/or a respective feature of the automated assistant. The method further includes, subsequent to selecting the interaction cohorts for classifying the user and/or the one or more prior interactions: generating first assistant content based on a first interaction cohort of the interaction cohorts, and second assistant content based on a second interaction cohort of the interaction cohorts, and causing the computing device or the separate computing device to render the first assistant content and/or the second assistant at the interface, in furtherance of informing the user about one or more features employed by, or not employed by, the user during the prior interaction. Notably, the first assistant content and the second assistant content are generated for rendering at an interface of the computing device and/or a separate computing device.

These and other implementations of technology disclosed herein can optionally include one or more of the following features.

In some implementations, the first assistant content may characterize a suggestion regarding a first feature of the automated assistant and the second assistant may characterize a different suggestion regarding a second feature of the automated assistant.

In some versions of those implementations, the first feature may correspond to controlling, via the automated assistant, a vehicle that the computing device is attached, and the second feature may correspond to controlling, via the automated assistant, a separate application from the automated assistant.

In some implementations, the method may further include, subsequent to selecting the interaction cohorts for classifying the user and/or the one or more prior interactions, determining that the user is estimated to reduce engagement with the first feature or the second feature at a particular time, or within a threshold duration of the particular time. Causing the computing device or the separate computing device to render the first assistant content and/or the second assistant at the interface may be performed in response to determining that the user is estimated to reduce engagement with the first feature or the second feature.

In some implementations, the method may further include, subsequent to selecting the interaction cohorts for classifying the user and/or the one or more prior interactions, determining that the user is estimated to reduce engagement with the computing device or the separate computing device at a particular time, or within a threshold duration of the particular time. Causing the computing device or the separate computing device to render the first assistant content and/or the second assistant content at the interface may be performed in response to determining that the user is estimated to reduce engagement with the computing device or the separate computing device.

In some versions of those implementations, the interface may be a display interface that is integral to a vehicle, and the first assistant content and/or the second assistant content may be rendered at the display interface simultaneous to other assistant content being rendered at the display interface.

In some implementations, a method implemented by one or more processors is provided, the method includes determining, based on client interaction data, a prior interaction a user has had with an automated assistant that is accessible via a computing device. The client interaction data is generated based on the prior interaction between the user and the automated assistant. The method further includes selecting, based on the prior interaction the user had with the automated assistant, a first interaction cohort for classifying the user and/or the prior interaction. The first interaction cohort is selected from a plurality of interaction cohorts that vary according to an estimated level of experience a particular user has had with: the automated assistant and/or a feature of the automated assistant. The method further includes determining, based on additional client interaction data, a separate prior interaction the user had with the automated assistant. The additional interaction data is generated based on the separate prior interaction between the user and the automated assistant. The method further includes selecting, based on the separate prior interaction the user had with the automated assistant, a second interaction cohort from the plurality of interaction cohorts for classifying the user and/or separate prior interaction, and subsequent to selecting the first interaction cohort and the second interaction cohort: generating, based on the first interaction cohort and/or the second interaction cohort, assistant content for rendering at an interface of the computing device or a separate computing device; and causing the computing device or the separate computing device to render the assistant content at the interface, in furtherance of informing the user about one or more features employed by, or not employed by, the user during the prior interaction and/or the separate prior interaction.

These and other implementations of technology disclosed herein can optionally include one or more of the following features.

In some implementations, the computing device and the interface may be integral to a vehicle and the one or more features may involve controlling the vehicle using the automated assistant, and the assistant content may include a graphical indication of a vehicle button for invoking the automated assistant.

In some implementations, the one or more features may involve controlling a separate application via the automated assistant, and the assistant content may include natural language content specifying a spoken utterance to provide to the automated assistant for controlling the separate application.

In some implementations, the first interaction cohort may correspond to users who have had more interactions with the feature of the automated assistant than another user who is assigned to the second interaction cohort.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A method implemented by one or more processors, the method comprising:
determining, based on client interaction data, a prior interaction a user has had with an automated assistant that is accessible via a computing device,
wherein the client interaction data is generated based on the prior interaction between the user and the automated assistant;
selecting, based on the prior interaction the user had with the automated assistant, a particular interaction cohort for classifying the user and/or the prior interaction,
wherein the particular interaction cohort is selected from a plurality of interaction cohorts that vary according to an estimated level of experience a particular user has had with the automated assistant and/or a feature of the automated assistant;
subsequent to selecting the particular interaction cohort for classifying the user and/or the prior interaction:
generating, based on the particular interaction cohort selected for the user and/or the prior interaction, assistant content for rendering at an interface of the computing device or a separate computing device,
wherein different assistant content is generated for other users associated with other interaction cohorts of the plurality of interaction cohorts; and
causing the computing device or the separate computing device to render the assistant content at the interface, in furtherance of informing the user about one or more features employed by, or not employed by, the user during the prior interaction.

2. The method of claim 1, further comprising:
subsequent to causing the computing device or the separate computing device to render the assistant content at the interface:
determining, based on subsequent client interaction data, a subsequent interaction, or lack of interaction, between the user with the automated assistant,
wherein the subsequent client interaction data is generated based on the subsequent interaction, or lack of interaction, between the user and the automated assistant; and
causing one or more trained machine learning models to be further trained based on the subsequent interaction, or lack of interaction, between the user and the assistant content,
wherein generating the assistant content for rendering at the interface involves utilizing the one or more trained machine learning models.

3. The method of claim 2, further comprising:
subsequent to causing the computing device or the separate computing device to render the assistant content at the interface:
selecting, based on the subsequent interaction of the user, a separate interaction cohort from the plurality of interaction cohorts,
wherein the separate interaction cohort corresponds to a more experienced user cohort relative to the particular interaction cohort.

4. The method of claim 2, further comprising:
subsequent to causing the computing device or the separate computing device to render the assistant content at the interface:
selecting, based on the subsequent interaction of the user, a separate interaction cohort from the plurality of interaction cohorts,
wherein the separate interaction cohort corresponds to a less experienced user cohort relative to the particular interaction cohort.

5. The method of claim 1, wherein the client interaction data indicates multiple different features of the automated assistant that the user has utilized via the computing device or the separate computing device.

6. The method of claim 1, further comprising:
subsequent to selecting the particular interaction cohort for classifying the user and/or the prior interaction:
determining that the user is estimated to reduce engagement with the automated assistant at a particular time, or within a threshold duration of the particular time,
wherein causing the computing device or the separate computing device to render the assistant content at the interface is performed at the particular time.

7. The method of claim 6,
wherein the computing device is a vehicle computing device that is directly attached to, and controls, a vehicle, and
wherein determining that the user is estimated to reduce engagement with the automated assistant is based on available interaction data indicating current or past engagement of the user with the vehicle computing device and/or the automated assistant.

8. The method of claim 7, wherein the available interaction data indicates that, at the particular time, the user has ceased controlling the vehicle within a threshold duration of time, and/or the vehicle is parked or stopped.

9. The method of claim 6,
wherein the automated assistant is an application that facilitates internet searching, and
wherein determining that the user is estimated to reduce engagement with the automated assistant is based on available interaction data indicating current or past engagement of the user with the application.

10. The method of claim 9, wherein the available interaction data indicates that, at the particular time, the application has, or has not, received an input from the user within a threshold duration of time.

11. A method implemented by one or more processors, the method comprising:
determining, based on client interaction data, one or more prior interactions a user has had with an automated assistant that is accessible via a computing device,
wherein the client interaction data is generated based on the one or more prior interactions between the user and features of the automated assistant;
selecting, based on the one or more prior interactions between the user and the features of the automated assistant, interaction cohorts for classifying the user and/or the one or more prior interactions,
wherein each interaction cohort of the interaction cohorts is selected from a plurality of interaction cohorts that vary according to a respective estimated level of experience a particular user has had with the automated assistant and/or a respective feature of the automated assistant;
subsequent to selecting the interaction cohorts for classifying the user and/or the one or more prior interactions:
generating first assistant content based on a first interaction cohort of the interaction cohorts, and second assistant content based on a second interaction cohort of the interaction cohorts,
wherein the first assistant content and the second assistant content are generated for rendering at an interface of the computing device and/or a separate computing device; and
causing the computing device or the separate computing device to render the first assistant content and/or the second assistant at the interface, in furtherance of informing the user about one or more features employed by, or not employed by, the user during the prior interaction.

12. The method of claim 11, wherein the first assistant content characterizes a suggestion regarding a first feature of the automated assistant and the second assistant characterizes a different suggestion regarding a second feature of the automated assistant.

13. The method of claim 12, wherein the first feature corresponds to controlling, via the automated assistant, a vehicle that the computing device is attached, and the second feature corresponds to controlling, via the automated assistant, a separate application from the automated assistant.

14. The method of claim 11, further comprising:
subsequent to selecting the interaction cohorts for classifying the user and/or the one or more prior interactions:
determining that the user is estimated to reduce engagement with the first feature or the second feature at a particular time, or within a threshold duration of the particular time,
wherein causing the computing device or the separate computing device to render the first assistant content and/or the second assistant at the interface is performed in response to determining that the user is estimated to reduce engagement with the first feature or the second feature.

15. The method of claim 11, further comprising:
subsequent to selecting the interaction cohorts for classifying the user and/or the one or more prior interactions:
determining that the user is estimated to reduce engagement with the computing device or the separate computing device at a particular time, or within a threshold duration of the particular time,
wherein causing the computing device or the separate computing device to render the first assistant content and/or the second assistant content at the interface is performed in response to determining that the user is estimated to reduce engagement with the computing device or the separate computing device.

16. The method of claim 15, wherein the interface is a display interface that is integral to a vehicle, and the first assistant content and/or the second assistant content are rendered at the display interface simultaneous to other assistant content being rendered at the display interface.

17. A method implemented by one or more processors, the method comprising:
determining, based on client interaction data, a prior interaction a user has had with an automated assistant that is accessible via a computing device,
wherein the client interaction data is generated based on the prior interaction between the user and the automated assistant;
selecting, based on the prior interaction the user had with the automated assistant, a first interaction cohort for classifying the user and/or the prior interaction,
wherein the first interaction cohort is selected from a plurality of interaction cohorts that vary according to an estimated level of experience a particular user has had with: the automated assistant and/or a feature of the automated assistant;
determining, based on additional client interaction data, a separate prior interaction the user had with the automated assistant,
wherein the additional interaction data is generated based on the separate prior interaction between the user and the automated assistant;
selecting, based on the separate prior interaction the user had with the automated assistant, a second interaction cohort from the plurality of interaction cohorts for classifying the user and/or separate prior interaction;
subsequent to selecting the first interaction cohort and the second interaction cohort:
generating, based on the first interaction cohort and/or the second interaction cohort, assistant content for rendering at an interface of the computing device or a separate computing device; and
causing the computing device or the separate computing device to render the assistant content at the interface, in furtherance of informing the user about one or more features employed by, or not employed by, the user during the prior interaction and/or the separate prior interaction.

18. The method of claim 17, wherein the computing device and the interface are integral to a vehicle and the one or more features involve controlling the vehicle using the automated assistant, and the assistant content includes a graphical indication of a vehicle button for invoking the automated assistant.

19. The method of claim 17, wherein the one or more features involve controlling a separate application via the automated assistant, and the assistant content includes natural language content specifying a spoken utterance to provide to the automated assistant for controlling the separate application.

20. The method of claim 17, wherein the first interaction cohort corresponds to users who have had more interactions with the feature of the automated assistant than another user who is assigned to the second interaction cohort.
